(19) United States
(12) Patent Application Publication
(10) Pub. No.: US 2002/0036780 A1
(43) Pub. Date: Mar. 28, 2002

(54) Image processing apparatus

(76) Inventor: Hiroaki Nakamura, Kanagawa (JP)

Correspondence Address: BIRCH STEWART KOLASCH & BIRCH, PO BOX 747, FALLS CHURCH, VA, 22040-0747, US

(21) Appl. No.: 09/963,373

(22) Filed: Sep. 27, 2001

(30) Foreign Application Priority Data
Sep. 27, 2000 (JP) 2000-293780

(51) Int. Cl. B41B 1/00; G06F 15/00

(52) U.S. Cl. 358/1.2; 358/1.13

(57) ABSTRACT

An image processing apparatus includes a display, an image processing unit for subjecting an image supplied from an image data supply source to image processing, a memory for storing at least one first reference image, a registration unit for registering the at least one first reference image in the memory, a display unit for selecting at least one second reference image from the at least one first reference image and displaying on the display the at least one second reference image together with a finished-state-predicting image of the image processed by the image processing unit, and a first adjustment unit for adjusting the image processing conditions in the image processing unit by using the at least one second reference image displayed on the display and the finished-state-predicting image. With this arrangement, the image processing apparatus can perform effective verification with pinpoint accuracy.

### BACKGROUND OF THE INVENTION

The present invention relates to the technical field of an image processing apparatus utilized in a photoprinter and the like, and, more particularly, to an image processing apparatus capable of verification of images to be reproduced with pinpoint accuracy.

Most of images recorded on photographic films such as negative films and reversal films (which are hereinafter referred to as “films”) are conventionally printed onto light-sensitive materials (photographic paper) by a technique generally called “direct exposure” in which the image on a film is projected onto the light-sensitive material for exposure.

A printer that adopts digital exposure has recently been commercialized. In this “digital photoprinter”, an image recorded on a film is read photoelectronically and converted into digital signals, which are subjected to various kinds of image processing to produce recording image data; a light-sensitive material is exposed by scanning with recording light modulated in accordance with the image data, thereby recording a (latent) image, which is then developed to produce a photographic print.

Having these features, the digital photoprinter is composed of the following four basic components; a scanner (image reading apparatus) which applies light onto a film and reads the light projected therefrom, thereby photoelectronically reading the image recorded on the film; an image processing apparatus which performs predetermined processing to the image data read with the scanner to obtain image data for recording the image; a printer (image recording apparatus) which scan exposes a light-sensitive material with, for example, a light beam in accordance with the image data supplied from the image processing apparatus and records a latent image; and a processor (developing apparatus) which subjects the light-sensitive material exposed by the printer to development processing and creates a photographic print on which the image is reproduced.

According to this digital photoprinter, since an image can be appropriately processed by processing image data, it is preferably subjected to gradation adjustment, color balance adjustment, color and/or density adjustment, and the like. Thus, a photographic print of high quality that cannot be obtained by conventional direct exposure can be obtained.

Further, since the digital photoprinter handles an image as digital image data, it can output not only an image recorded on a film (image data read with a scanner) but also an image recorded by a digital camera, and the like and an image obtained by a communication network such as Internet as a photographic print. Further, the digital photoprinter can output not only a photographic print but also the image data of the image reproduced on the photographic print to various recording mediums such as a CD-R and an MO (magneto-optic) recording medium and to various communication networks as an image file.

Incidentally, so-called verification is performed to confirm the image of each frame of a film prior to photographic print output in order to output an appropriate photographic print not only in the digital photoprinter but also in a photoprinter of a conventional direct exposure type.

The verification is ordinarily performed in such a manner that the image recorded on each frame of a film is photoelectrically read with a CCD sensor or the like; an image processed in accordance with the image processing conditions (an amount of insertion of a filter, a stop-down value of exposed light, and the like in a direct exposure apparatus) that have been set in accordance with the image of each frame, that is, a finished-state-predicting image (image to be verified) is displayed on a display; and the image processing conditions having been set are corrected by correcting the displayed image as necessary.

Further, a print to be used as a reference is output beforehand and verification is performed with reference to the reference print which is placed beside the display so that the verification can be performed with higher accuracy.

In this method, however, the image reproduced on the display and the image reproduced on the reference print are often observed differently because they are observed under different observing conditions, for example, the positions of them with respect to an observation light source, and the like. As a result, a problem arises in that the accuracy of verification is lowered because the reference print cannot be preferably observed, that is, a print cannot be output in coincidence with the reference print.

### SUMMARY OF THE INVENTION

Accordingly, it is an object of the present invention to solve the problem of the conventional art and to provide an image processing apparatus capable of more effective verification with pinpoint accuracy in a photoprinter by preventing or controlling the reduction of verification accuracy caused by the difference between the observing conditions under which a reference print is observed and the observing conditions under which an image to be verified is observed, regardless of whether printing of digital exposure type or direct (analog) exposure type is made, whereby an appropriate photographic print on which an image of high quality is reproduced, can be stably output at a high production efficiency.

In order to attain the object described above, the present invention provides an image processing apparatus comprising: a display; an image processing unit for subjecting an image supplied from an image data supply source to image processing based on image processing conditions; a memory for storing at least one first reference image; a registration unit for registering the at least one first reference image in the memory; a display unit for selecting at least one second reference image from the at least one first reference image and displaying on the display the at least one second reference image together with a finished-state-predicting image of the image processed by the image processing unit; and a first adjustment unit for adjusting the image processing conditions in the image processing unit by using the at least one second reference image displayed on the display and the finished-state-predicting image.

It is preferable that the image processing apparatus, further comprises a moving unit for moving the second reference image displayed on the display.

It is also preferable that the image processing apparatus further comprises at least one of a reference image enlargement/reduction unit for enlarging or reducing the second reference image and a reference image partial display unit for partially displaying the second reference image.

It is another preferable that the image processing apparatus further comprises an output unit for outputting the first reference image stored in the memory as a hard copy; and a second adjustment unit for adjusting color and density of the first reference image stored in the memory.

Preferably, the registration unit registers a plurality of first reference images for each group corresponding to an image scene and the display unit displays the plurality of first reference images for the each group.

Preferably, the image processing unit also processes the finished-state-predicting image by using image processing conditions of the first reference image registered in the memory.

Preferably, a color and a density residual of a calibration of an output device to which the image processed in the image processing unit is output are reflected on each of the first and second reference images.

Preferably, an output device to which the image processed in the image processing unit is output and an output form used are selectable and the first adjustment unit modifies image processing conditions for the finished-state-predicting image in accordance with the output device and output form selected.

Preferably, the registration unit registers image processing conditions for the finished-state-predicting image as image processing conditions for the first reference image.

Preferably, the display unit displays the second reference image and the finished-state-predicting image in a partially overlapped state on the display and indicates by color or density a magnitude of at least one of a color difference and a difference in an image structure index between the second reference image and the finished-state-predicting image in the partially overlapped state.

It is further preferable that the image processing apparatus further includes a unit for designating specific regions in the second reference image and the finished-state-predicting image displayed on the display, wherein the display unit indicates by color or density a magnitude of at least one of a color difference and a difference in an image structure index between the designated regions.

Preferably, the image structure index is a power spectrum.

Preferably, the memory stores the first reference image by colorimetric values.

Preferably, the colorimetric values are XYZ values in a CIE1931 standard colorimetric system or L*a*b* values in a CIE1976L*a*b* perceived color space.

Preferably, the memory stores the first reference image by values on a standard color space.

Preferably, the standard color space is a sRGB trichromatic system.

### BRIEF DESCRIPTION OF THE DRAWINGS

FIG. 1 is a block diagram of an example of a digital photoprinter making use of an image processing apparatus of the present invention;

FIG. 2 is a block diagram of an embodiment of the image processing apparatus of the digital photoprinter shown in FIG. 1;

FIG. 3 is a schematic view of an example of a verification screen in the digital photoprinter shown in FIG. 1;

FIG. 4 is a schematic view of another example of the verification screen in the digital photoprinter shown in FIG. 1; and

FIG. 5 is a schematic view of still another example of the verification screen in the digital photoprinter shown in FIG. 1.

### DETAILED DESCRIPTION OF THE INVENTION

An image processing apparatus of the present invention will be described below in detail with reference to a preferable embodiment shown in the accompanying drawings.

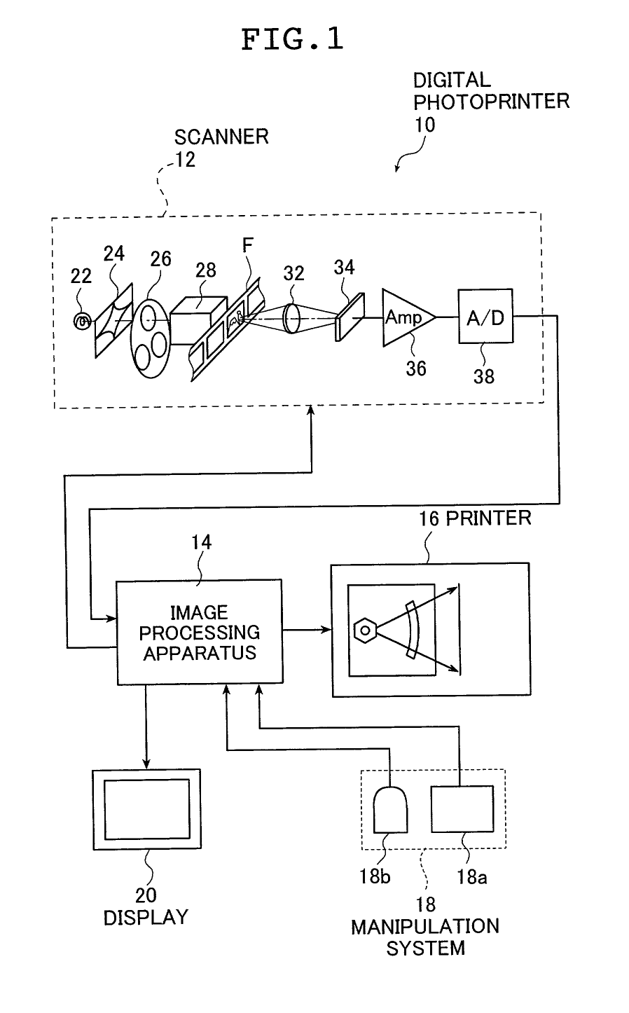

FIG. 1 shows a block diagram of an example of a digital photoprinter making use of the image processing apparatus of the present invention.

The digital photoprinter generally indicated by 10 in FIG. 1 and which is referred to simply as the “photoprinter” basically includes a scanner (image reading apparatus) 12, the image processing apparatus 14 and a printer 16.

Further, to the image processing apparatus 14 are connected a manipulation system 18 and a display 20. The manipulation system 18 includes a keyboard 18a and a mouse 18b, and the display 20 displays a finished-state-predicting image (simulation image) used in verification of an image to be reproduced on a photographic print, that is, an image to be verified. Further, the keyboard 18a includes various adjustment keys such as a density adjustment key, color adjustment keys for the respective colors of C (cyan), M (magenta) and Y (yellow), a gradation (γ) adjustment key, and a sharpness adjustment key which are used for adjusting as required an image and hence image processing conditions when verification is performed. It should be noted here that these various adjustment keys may be provided on a display screen of the display 20 in the form of GUI (graphical user interface) so that the operation can be made with the manipulation system 18.

The scanner 12 is an apparatus with which images recorded on a film F or the like are read photoelectrically frame by frame, and includes a white light source 22, a variable diaphragm 24, a color filter plate 26, a diffuser box 28 with which reading light incident on the film F is made uniform on the plane thereof, an imaging lens unit 32, an area CCD sensor 34 (hereinafter simply referred to as “CCD sensor 34”), an amplifier 36, and an A/D (analog/digital) converter 38.

Further, the photoprinter 10 has dedicated carriers available that can be selectively mounted in the housing of the scanner 12 in accordance with the size of a film such as a film for an Advanced Photo System, a film of 135 size, and the like. An image (frame) from which a print is created is transported to and held at a predetermined reading position by a carrier.

When an image recorded on the film F is read in the scanner 12, reading light issuing from the light source 22 is adjusted in quantity by passage through the variable diaphragm 24, then passes through the color filter plate 26 for color adjustment, and is diffused in the diffuser box 28; the thus diffused reading light is incident on the film F that is held at a predetermined reading position by a carrier, and passes therethrough to thereby produce projected light that carries the image recorded on the film F.

The projected light passes through the imaging lens unit 32 and is focused on the light-receiving plane of the CCD sensor 34, and the image recorded on the film F is photoelectrically read.

The output signal from the CCD sensor 34 is amplified with the amplifier 36, converted into a digital signal with the A/D converter 38, and then sent to the image processing apparatus 14.

The color filter plate 26 is a turret provided with red (R), green (G), and blue (B) filters and is rotated by a known rotating unit so as to insert the respective filters into the path of the reading light. In the illustrated scanner 12, the respective color filters of the color filter plate 26 are sequentially inserted and the image is read three times so that the image recorded on the film F is separated to three primary colors of R, G, and B and read.

The scanner 12 reads the image recorded on the film F twice. That is, the scanner 12 carries out prescan for reading the image at a low resolution and fine scan for obtaining image data adapted for outputting a print and an image file.

Prescan is performed under conditions that are previously set in accordance with the prescan in order to ensure that all the images of the film F to be handled by the scanner 12 can be read without saturating the CCD sensor 34. In contrast, fine scan is performed under conditions that are set for each frame in accordance with the prescanned data and the output size of an image delivered from the image processing apparatus 14.

Accordingly, the output signals for prescan and fine scan are basically the same except for the resolution in image reading and the output level.

In the photoprinter 10 (image processing apparatus 14) according to the present invention, the scanner 12 for reading image is not limited to the illustrated one and various known scanners can be used. For example, a scanner that reads an image by separating it to three primary colors and which employs a light source individually emitting reading light for three primary colors with LEDs or the like may be used. Alternatively, a scanner of slit scan exposure type using line CCD sensors for three colors may be used.

In addition to the scanner for reading the image recorded on a film, the image processing apparatus of the present invention may receive image data (image) from various kinds of image data supply sources (image supply sources) and process the thus received image data (image). Exemplary image data supply sources include an image reading apparatus for reading a reflecting original, an imaging device such as a digital camera, a communication network such as a computer communication network, and a recording medium (and its drive) such as a floppy disc.

As described above, the output signal (image data) from the scanner 12 is supplied to the image processing apparatus 14.

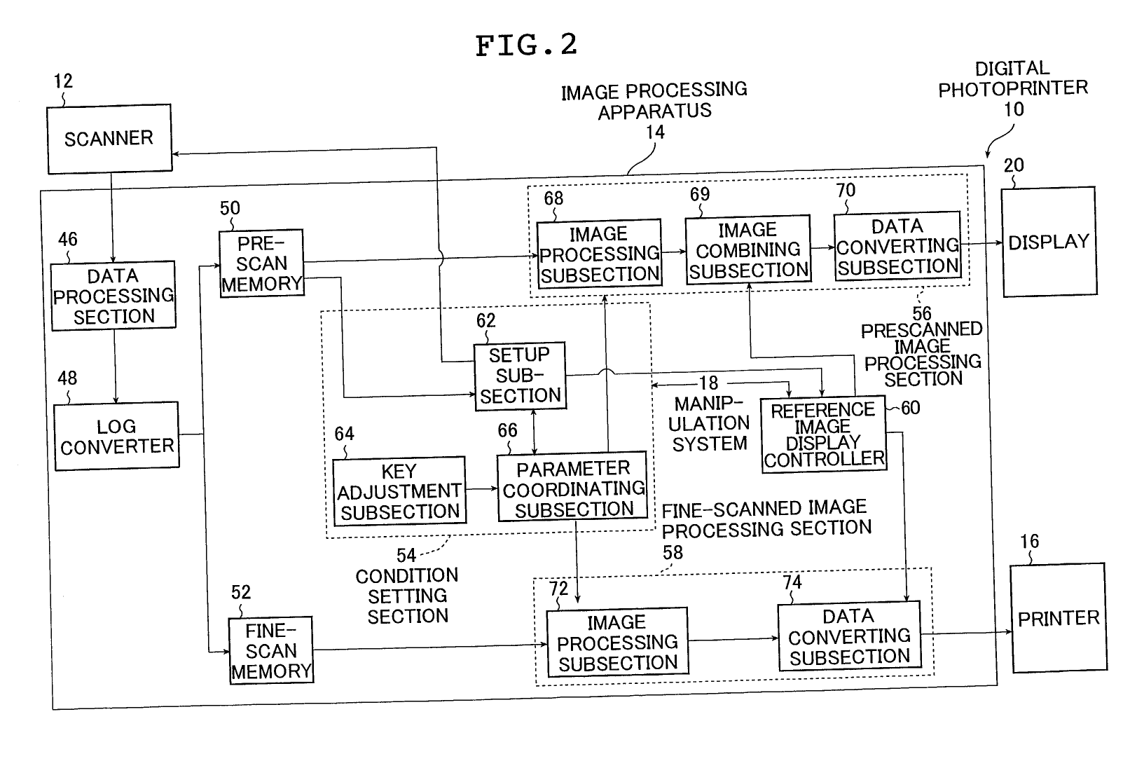

FIG. 2 shows a block diagram of the image processing apparatus 14. As shown in FIG. 2, the image processing apparatus 14 (hereinafter, referred to as “processing apparatus 14”) includes a data processing section 46, a Log converter 48, a prescan (frame) memory 50, a fine-scan (frame) memory 52, a condition setting section 54, a prescanned image processing section 56, a fine-scanned image processing section 58, and a reference image display controller 60 (hereinafter, referred to as “reference image controller 60”).

While FIG. 2 mainly shows the sites that are related to image processing, the processing apparatus 14 also controls and manages the photoprinter 10 in its entirety including the operation of the respective sections in accordance with the output method selected. In addition to the components shown in FIG. 2, the processing apparatus 14 also includes a CPU that controls the photoprinter 10 as a whole and a memory which stores the information necessary for the operation and the like of the photoprinter 10.

The data processing section 46 subjects the R, G, B data output from the scanner 12 to predetermined processing such as DC offset correction, darkness correction and shading correction.

The Log converter 48 subjects the output data having been processed in the data processing section 46 to Log conversion with, for example, a LUT (look-up table) or the like to obtain digital image (density) data including prescanned (image) data and fine-scanned (image) data. The prescanned (image) data is stored in the prescan memory 50, and the fine-scanned (image) data is stored in the fine-scan memory 50.

The condition setting section 54 includes a setup subsection 62, a key adjustment subsection 64 and a parameter coordinating subsection 66.

The setup subsection 62 sets fine-scanning conditions and image processing conditions for each frame in accordance with the image analysis performed using the prescanned data, various instructions input by the operator, and the like.

Specifically, the setup subsection 62 uses the prescanned data to create an image density histogram and calculate image characteristic amounts such as a minimum density, a maximum density and an average density.

Subsequently, the setup subsection 62 sets reading conditions for fine scan so that the CCD sensor 34 is saturated at a density slightly lower than the minimum density of a particular image (frame) by using the above information. The setup subsection 62 uses the calculated density histogram and image characteristic amounts, an exposed state, resolution in reading, an output size, and so on to further calculate various image processing conditions such as a sharpness gain, look-up tables (LUTs) for performing various types of image processing in image processing subsections 68 and 72 to be described later. Note that calculation of the various image processing conditions depending on the image analysis can be carried out by a known calculation method in accordace with the image processing to be executed.

In the key adjustment subsection 64, the finished-state-predicting image which is displayed on the verification screen of the display 20 as an image to be verified is verified by using reference images displayed on the same verification screen at a time. Then, image adjustment amounts are calculated in accordance with instructions for various adjustments which were input based on the results of the verification by means of various adjustment keys such as the aforementioned color/density adjustment key set on the keyboard 18a or on the display screen of the display 20 in the form of GUI. The thus calculated image adjustment amounts are supplied to the parameter coordinating subsection 66. The reference image will be described later.

The parameter coordinating subsection 66 receives the various image processing conditions calculated by the setup subsection 62 and sets them at the predetermined positions of the prescanned image processing section 56 and the fine-scanned image processing section 58. Further, the parameter coordinating subsection 66 adjusts (corrects) the image processing conditions set to the respective sections in accordance with the image adjustment amounts calculated in the key adjustment subsection 64, creates processing conditions for adjustment, and sets the processing conditions to both the image processing sections 56 and 58.

In the processing apparatus 14, based on the image processing conditions that have been calculated in the setup subsection 62 of the condition setting section 54 and set to each of the image processing sections 56 and 58 by the parameter coordinating subsection 66, the prescanned data stored in the prescan memory 50 and the fine-scanned data stored in the fine-scan memory 52 are processed in the prescanned image processing section 56 and the fine-scanned image processing section 58, respectively.

The prescanned image processing section 56 includes the image processing subsection 68, an image combining subsection 69, and a data converting subsection 70. On the other hand, the fine-scanned image processing section 58 includes the image processing subsection 72 and a data converting subsection 74.

The image processing subsection 68 of the prescanned image processing section 56 and the image processing subsection 72 of the fine-scanned image processing section 58 basically have the same arrangement except for the pixel density of the image data to be processed and thus they basically perform the same processing.

Accordingly, the image processing subsection 72 of the fine-scanned image processing section 58 will be described below as a representative example.

In the illustrated example, the image processing subsection 72 (68) performs various types of image processing, for example, electronic magnification processing, color balance correction, density correction, gradation correction, saturation correction, dodging processing, sharpness processing, and the like by a known method using LUTs, matrix operations, various filters such as low-pass filters (LPFs), and the like.

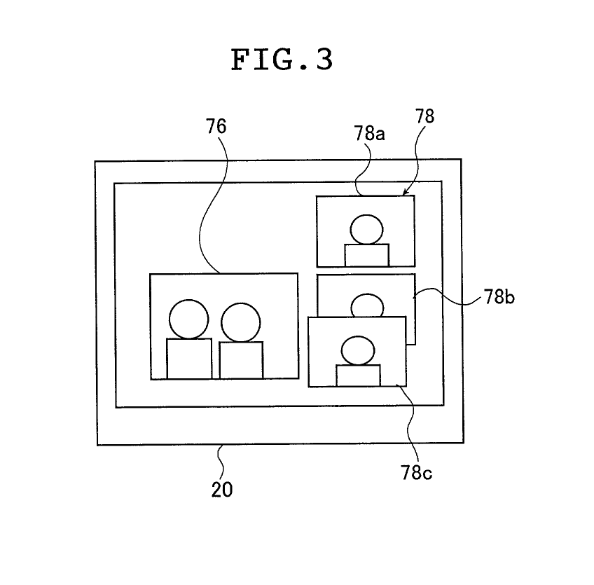

Prescanned data having been processed in the image processing subsection 68, that is, image data of an image to be verified is sent to the image combining subsection 69. Further, image data of at least one reference image is also sent to the image combining subsection 69 from the reference image controller 60 to be described later. An example is shown in FIG. 3, according to which the image combining subsection 69 creates image data for displaying an image to be verified 76 together with reference images 78 (78a, 78b and 78c) on the verification screen of the display 20 in a specified arrangement. The thus created image data is then sent to the data converting subsection 70.

On the other hand, fine-scanned data having been processed in the image processing subsection 72 is sent to the data converting subsection 74.

The respective data converting subsections 70 and 74 are sections for converting images using, for example, a 3D (three-dimensional)-LUT and the like. That is, the data converting subsection 70 converts prescanned image data into a form adapted for displaying on the display 20, whereas the data converting subsection 74 converts fine-scanned image data into a form adapted for image recording by the printer 16.

The image data having been converted in the data converting subsection 70 of the prescanned image processing section 56 is sent to the display 20 and displayed thereon.

The display 20 is not particularly limited, and various known display devices such as a CRT (cathode ray tube), a liquid crystal display (LCD) and a plasma display panel (PDP) can be utilized.

On the other hand, the image data having been converted in the data converting subsection 74 of the fine-scanned image processing section 58 is sent to the printer 16. It should be noted that the processing apparatus 14 of the present invention may have as required a plurality of data converting subsections 74 which are connected to a plurality of printers 16 (network may also be utilized) and dedicated to these printers.

The printer 16 records a latent image by exposing a light-sensitive material (photographic paper) with light modulated in accordance with image data output from the fine-scanned image processing section 58, develops the latent image in accordance with the type of the light-sensitive material, and outputs the thus developed image as a (finished) print.

In the photoprinter 10, the form in which the image (image data) processed in the processing apparatus 14 of the present invention is output may be image reproduction on a photographic print, image reproduction on a display or output of image data per se. Accordingly, the destination of the image (image data) after the image processing has been performed is not limited to the illustrated printer 16 or display 20. The processed image (image data) may be output to another printer or display connected to the processing apparatus 14 directly or through a communication network such as Internet or a computer communication network; another image processing apparatus connected to the processing apparatus 14; a printer or a display connected to this image processing apparatus; a drive for recording image data per se on an image data recording medium such as an FD (floppy disc) or an MD (magneto-optic) disc; or a communication device for delivering image data per se through the communication network as described above.

When the processing apparatus 14 is capable of outputting the processed image (image data) to a plurality of output devices having difference output forms, the output form or output device to be used can be selected by the manipulation system 18. The setup subsection 62 can preferably change the image processing conditions for the image to be verified (finished-state-predicting image) in accordance with the output form or output device selected.

The reference image controller 60 is a section where a memory is buit-in and a reference image (image data thereof) is registered and stored. When verification is performed, the reference image controller 60 reads out the image data of the reference image stored in the memory to supply to the image combining subsection 69, as described above.

The reference image is an image to be referred to for appropriately performing the verification, in other words, for appropriately adjusting a finished-state-predicting image in the verification as in a conventionally used reference print. A plurality of reference images are preferably prepared and registered in the reference image controller 60 for various scenes photographed.

A method of registering a reference image is not particularly limited, and various methods may be illustrated.

An exemplary method comprises storing image data of a verified image (finished-state-predicting image) of a frame which seems preferable as a reference image and registering the verified image as a reference image when a print of the frame is excellent in image quality. It is preferable that the image processing conditions used when the image (finished-state-predicting image) verified and registered as a reference image has been processed can also be registered in association with the image registered as the reference image.

The image (image data) obtained by reading the conventionally used reference print with the scanner 12 may be registered. When image data for reference print output is stored in a database, an image data recording medium or another image processing apparatus, the image data may be downloaded or read out for registration. In the latter case, it is preferable to register, if possible, the image processing conditions of the reference print at a time in association with the image data.

In the processing apparatus 14 of the present invention, the pattern of a reference image to be registered is not basically limited and any pattern can be appropriately selected in accordance with the image to be processed. Exemplary images include a close-up image of a face; a portrait; an image of a person belonging to different races such as a black person, a white person or a yellow person; an image of a landscape of sea, sky, mountain, grassy plain, forest, or the like; an image of a living thing in the natural world such as flower, animal or fish; an image of a person with a dress of a particular color such as a red dress or a white dress. A plurality of images may be registered for a single scene.

Further, the reference image need only be an image having information of various scenes as described above. Thus, the reference image may be obtained by actually photographing various scenes or created by using computer graphics and the like.

It is preferable that the reference images be divided into groups each containing the same scene, for example, into a group of portraits, a group of close-up face images, a group of landscapes, and the like and that a plurality of images be registered in each group (hereinafter, a group of the same scene is referred to as the “same scene group”).

Further, it is also preferable that images be divided into groups each containing the same pattern, for example, a group of Japanese portraits, a group of portraits of whites, a group of Japanese close-up face images, a group of scenes of sea, a group of females with red dresses after grouping has been optionally made for each scene, and that a plurality of images be registered in each group (hereinafter, a group of the same pattern is referred to as the “same pattern group”).

It is needless to say that the grouping may be made according to a plurality of factors. Further, the names of the same scene groups and the same pattern groups may be selected from previously determined names, or the operator may optionally determine the names thereof. Alternatively, these two methods may be made selectable.

Note that when the photoprinter 10 includes a plurality of printers 16 (when a plurality of printers 16 are connected to the processing apparatus 14), it is preferable that a reference image be registered in each of the printers 16.

When the printer 16 connected to the processing apparatus 14 is replaced with another printer or the state of the printer 16 is changed, an image to be verified based on which an appropriate print can be output is also changed. Therefore, the color and/or density of an appropriate reference image are also changed.

To cope with this problem, it is preferable that the processing apparatus 14 of the present invention includes a color/density adjustment unit for adjusting the color, density, and the like of a registered reference image. For example, the illustrated processing apparatus 14 can set the adjustment mode for a reference image, perform as required the color/density adjustment of the reference image by using adjustment keys on the keyboard 18a or adjustment keys in the form of GUI while the reference image is displayed on the display 20, and then store the adjusted image data as the reference image in the reference image controller 60.

The reference image controller 60 preferably stores the reference image by colorimetric values such as XYZ values in the CIE1931 standard colorimetric system or L*a*b* values in the CIE1976L*a*b* perceived color space, or values in the standard color space such as the sRGB trichromatic system. The reference image data can be thus stored as the image data defined by the color reproduction range that does not depend on the input/output devices used, in other words, the colorimetric system or color space, which can facilitate adaptation to the case in which a plurality of image supply sources (input devices) including the scanner 12 are connected to the processing apparatus 14 of the present invetion, or to the case in which a plurality of output devices including the printer(s) 16 and the display(s) 20 are connected to the processing apparatus 14 of the present invention, irrespective of the color reproduction ranges of the input/output devices used or irrespective of the colorimetric system or color space used for defining the image data and which ensures convertion to the image data having the same color reproduction range.

Further, it is preferable to output the reference image as a hard copy from the printer 16 connected to the processing apparatus 14 so that the adjustment as described above can be performed more appropriately. With this operation, it is possible to adjust the reference image while observing an actual print.

In the illustrated example, the image data of the reference image is supplied from the reference image controller 60 to the data converting subsection 74 of the fine-scanned image processing section 58 and converted into image data adapted for the printer 16 in the data converting subsection 74, and a print on which the reference image is reproduced is output from the printer 16.

As described above, the reference image controller 60 supplies a registered reference image to the image combining subsection 69 when verification is performed.

Note that while one reference image may be displayed, it is preferable to display a plurality of reference images (the number of reference images is not limited to three in the illustrated examples). Further, the operator may set the number of reference images to be displayed.

The reference image controller 60 may select an image similar to an image to be verified as a reference image to be displayed through an analysis performed using image data, or the operator may select a reference image using the GUI. Alternatively, both the methods may be used together or selectively. Only the image to be verified may be displayed on the display 20 beforehand so that the operator can easily select the reference image.

Further, it is also preferable to select reference images on the same scene group or same pattern group basis by means of the image analysis performed by the reference image controller 60 or by the name of the group input by the operator and to further perform image selection as required among the above reference images, thereby determining a reference image to be displayed.

Note that, if reference images are registered in correspondence with a plurality of printers 16, it is of course preferable to select a reference image corresponding to a printer 16 to be used.

In order to perform more satisfactory verification in the present invention, it is preferable that a reference image be optionally movable in the screen of the display 20 through manipulation using the GUI or the like so that the comparative observation with the image to be verified beside the reference image or the comparative observation for each portion such as a cheek can be made. Further, when a plurality of reference images are displayed in a partially-overlapping-state as shown in FIG. 3, it is preferable to optionally change the image displayed uppermost by clicking the mouse 18b or other operation.

It is also preferable that any reference image can be selected from reference images being displayed by the operation using the GUI or the like and then enlarged or reduced. It is further preferable that a part of the reference image such as a close-up face can be optionally displayed in an enlarged state (partially displayed) by clicking or region designation with the mouse 18b. Furthermore, a reference image which has high frequency of enlargement may be displayed in an enlarged state from the beginning.

The image being displayed may be processed by a known method.

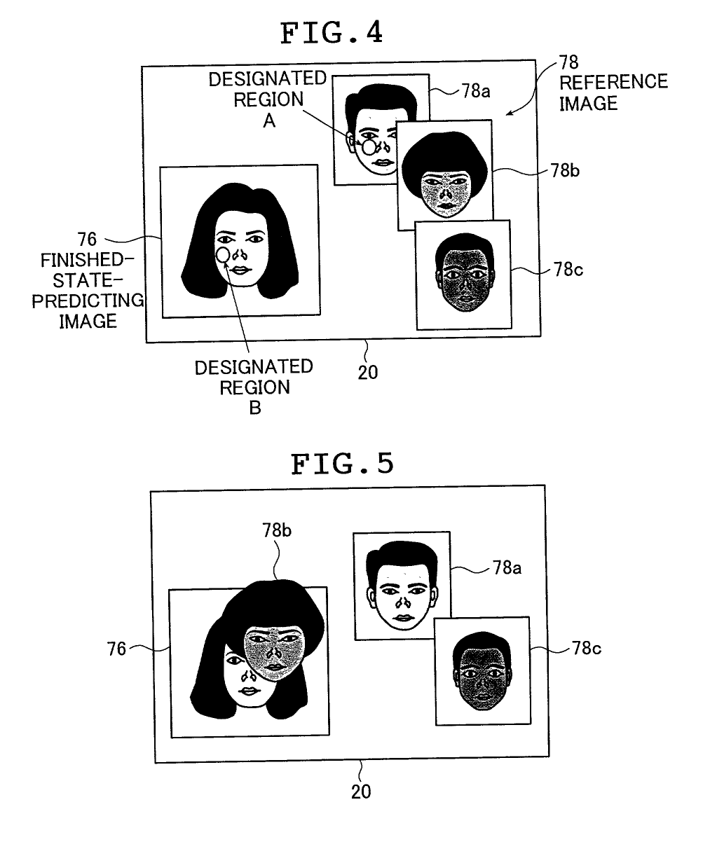

Further, in order to perform more satisfactory verification, it is preferable in the present invention to facilitate accurate verification by designating specific regions in one of the reference images 78 and the image to be verified (finished-state-predicting image) 76 displayed on the display 20 by clicking or region designation with the manipulation system 18 such as the keyboard 18a and the mouse 18b and indicating by color or density the magnitude of at least one of the color difference and the difference in the image structure index such as power spectrum between the designated regions, which is shown in FIG. 4. In an example shown in FIG. 4, the color difference or the difference in the image structure index between the designated region A of the reference image 78a and the designated region B of the finished-state-predicting image 76, in other words, the difference in the finished state between the designated regions A and B are preferably indicated by color or density within the designated region B. It should be noted here that indication of the difference in the finished state by color or density may be performed within the designated region A.

Another exmaple is shown in FIG. 5, according to which it is preferable to facilitate accurate verification by displaying one of the reference images 78 and the finished-state-predicting image 76 in an overlapped state on the display screen of the display 20 by a direct operation with the manipulation system 18 such as the keyboard 18a or the mouse 18b or by an operation with the GUI or the like via the manipulation system 18, and indicating by color or density the magnitude of at least one of the color difference or the difference in the image structure index such as power spectrum between the images overlapped with each other. According to the example shown in FIG. 5, the color difference or the difference in the image structure index between the reference image 78b and the finished-state-predicting image 76 overlapped therewith, in other words, the difference in the finished state between these images are preferably indicated by color or density within the reference image 78b, but may be indicated within the finished-state-predicting image 76.

The color and density of an image displayed on the display 20 are not uniform on the entire surface of a screen but different depending upon the positions thereof (for example, they are different at the center and the four corners of the screen).

In the present invention, in order to perform satisfactory verification which can obviate the defect as mentioned above, it is preferable to correct the color and/or density of a reference image (and further the image to be verified) in accordance with the positional unevenness of color and/or density on the display 20 as determined by the calibration of the display 20 and display the thus corrected reference image (and the image to be verified) on the verification screen of the display 20. The color and/or density of the reference image or image to be verified which is displayed on the verification screen can be corrected for example in the image combining subsection 69.

It is needless to say that the reference images (and the image data thereof) registered in the reference image controller 60 are preferably not changed.

Calibration is also performed in the printer 16 to output a print on which an appropriate image is reproduced if developing conditions are changed by replacement of a development liquid, and the like, or if the light-sensitive material (photographic paper) used is different from the one hitherto used, or if the environment in use (in particular environmental temperature) is changed, or if a secular change is caused. A margin is ordinarily set in the adjustment performed by the calibration. When the margin is, for example, ±0.02 in a density D with respect to the target density value of the respective colors of C, M, and Y, it is deemed that calibration has been performed appropriately and prints are output subsequently.

In the present invention, it is preferable to output again an image acting as a reference for a calibration chart or the like from the printer 16 after calibration has been performed in the printer 16, to measure the density of the image to detect a difference between the density of the image and the target density value of the calibration (hereinafter, referred to as a “calibration residual”), to correct the color/density of a reference image (and further those of an image to be verified) in accordance with the calibration residual, and to display the corrected reference image (and image to be verified) on the verification screen of the display 20.

As in the previous case, the color/density of a reference image or an image to be verified which is displayed on the verification screen need only be corrected for example in the image combining subsection 69. Further, even if the correction is performed, the reference images registered in the reference image controller 60 are preferably not changed.

When an image to be verified (finished-state-predicting image) is displayed on the verification screen of the display 20, if the reference image is registered in the reference image controller 60 together with the image processing condistions thereof, the image to be verified (finished-state-predicting image) that is to be displayed or has been displayed on the verification screen of the display 20 can be subjected to image processing by using the registered image processing conditions of the reference image. The image to be verified can be thus finished similarly to the reference image deemed to be appropriate and displayed on the verification screen, which enables more accurate verification.

The operation of the photoprinter 10 will be described below.

First, a carrier corresponding to the film F used is mounted on the scanner 12 at the predetermined position thereof, and the film F is set to the carrier.

Next, necessary information such as a print size is input through the manipulation system 18 in response to an order from a customer. This information is sent to the respective sections of the photoprinter 10.

After necessary manipulation has been finished, the operator gives an instruction for starting creation of a print.

With this instruction, the stop-down value of the variable diaphragm 24 of the scanner 12, and the like are set in accordance with the reading conditions in prescan, subsequently the carrier transports the frame of the film F from which an image is read to a predetermined reading position, and the light projected from the film F forms a focused image on the CCD sensor 34, and the focused image is read with the CCD sensor 34. The focused image is read by sequentially inserting the respective color filters by rotating the color filter plate 26, whereby the image recorded on the film F is separated to R, G and B and photoelectrically read.

Prescan and fine scan may be performed frame by frame. Alternatively, all the frames or a plurality of predetermined frames may be continuously subjected to prescan and fine scan. An example in which prescan and fine scan are performed frame by frame will be described below.

The output from the CCD sensor 34 is amplified by the amplifier 36 and converted into a digital signal by the A/D converter 38, and the digital signal is sent to the processing apparatus 14. After the digital signal is subjected to predetermined processing such as offset correction in the data processing section 46, the processed signal is converted into digital image data in the Log converter 48 and stored in the prescan memory 50.

When the prescanned data is stored in the prescan memory 50, the setup subsection 62 reads out the prescanned data, sets the reading conditions of the fine scan by creating a density histogram and calculating image characteristic amounts as described above and sends the reading conditions to the scanner 12. Further, the setup subsection 62 calculates various image processing conditions and sends them to the parameter coordinating subsection 66. The parameter coordinating subsection 66 sets the thus set image processing conditions and the like to the predetermined positions of the prescanned image processing section 56 and the fine-scanned image processing section 58.

Next, the prescanned data is read out from the prescan memory 50 and processed in the image processing subsection 68, and the prescanned data having been processed, that is, the image data of an image to be verified is sent to the image combining subsection 69. Further, in this example, the reference image controller 60 receives a result of image analysis from the setup subsection 62 and identifies the scene of the frame of an analyzed image, selects a reference image having a similar scene, and sends the image data of the reference image to the image combining subsection 69.

The image combining subsection 69 allocates the image data of both the images to predetermined positions, creates the image data for displaying on the verification screen of the display 20, and sends it to the data converting subsection 70.

The data converting subsection 70 converts the image data into image data adapted for display on the display 20, the image to be verified is then displayed on the verification screen of the display 20.

In this example, as shown in FIG. 3, the image (image to be verified) of the frame from which a print is created is a portrait, and the reference image controller 60 selects three portraits from the registered reference images.

It is needless to say that when the operator determines that the reference images selected by the reference image controller 60 are not appropriate, he or she may select other reference images registered in the reference image controller 60 by means of the GUI or the like through the operation with the manipulation system 18 such as the keyboard 18a or the mouse 18b. Further, the operator may select reference images from the beginning. In this case, only the image to be verified may be previously displayed on the verification screen of the display 20 as described above so that he or she can easily select the reference images.

It should be noted here that the image to be verified may be the one having been subjected to image processing by using the image processing conditions of a reference image.

The operator performs verification using the image to be verified and the reference images while observing the verification screen of the display 20 as shown in FIG. 3 and optionally adjusts the image to be verified, thereby adjusting the image processing conditions.

The operator may adjust the image to be verified by an ordinary method in which the color, density, gradation, and the like of the image to be verified is adjusted by means of the respective adjustment keys for adjusting color, density, and the like that are set to the keyboard 18a or the GUI on the verification screen while observing the verification screen.

Alternatively, the operator may use the manipulation system 18 to designate (in areas or at points) the positions in which the color/density matching is desired in the reference images and the image to be verified which are displayed on the verification screen of the display 20 so that the color and density of the designated region in the image to be verified can be automatically matched to those of the reference image accordingly. Further, correction keys and amounts of adjustment which are necessary to perform appropriate adjustment may be indicated on the display 20 in accordance with the positions designated as described above. In an example as shown in FIG. 4, the difference in the color/density (color difference) or the difference in the image structure index such as power spectrum between the region A designated in the reference image 78a and the region B designated in the image to be verified 96, in other words, the difference in the finished state may be indicated by color and/or density within the designated region B or A. Alternatively, as shown in FIG. 5, both the images are displayed in a partially overlapped state and the difference in the finished state of the overlapped portions may be indicated by color and/or density on the corresponding portion of the reference image or the image to be verified.

A plurality of positions may be designated. In this case, it is preferable to perform correction so that the average distance between color differences at respective points is minimized. Further, weighting may be performed for each point.

A signal for the adjustment is sent to the key adjustment subsection 64, and the aforementioned processing performed by the key adjustment subsection 64 and the parameter coordinating subsection 66 also changes the image to be displayed on the display 20 in accordance with the input made for the adjustment by the operator.

When the operator determines that the image displayed on the display 20 is appropriate (verification is acceptable), he or she inputs the determination with the keyboard 18a or the like. With this operation, processing to be applied to the frame (image) is fixed.

As is apparent from the above description, the photoprinter 10 (processing apparatus 14) according to the present invention performs verification by displaying the reference image 78 on the display 20 together with the image to be verified without using a conventionally used reference print. With this operation, the reference image 78 and the image to be verified can be observed for comparison under the same conditions. Accordingly, the accuracy of the verification is not lowered due to the difference of the observing conditions and the like, unlike the case in which the reference print and the image to be verified are used, which enables stable output of an appropriate print by the verification with pinpoint accuracy.

Further, not a color sample such as a patch or a step wedge but an image having information of a scene and preferably a reference image similar to an image to be verified and in particular a reference image having been similarly finished are displayed, and the difference in the finished state between both the images can be further displayed as required. Therefore, verification can be performed satisfactorily and suitably with pinpoint accuracy in accordance with the continuity of images and photographed scenes with good and simple workability, whereby not only image quality but also productivity can be improved.

When the scanner 12 is set under the conditions set by the setup subsection 62 as described above, fine scan is started in response to the instruction that the verification is acceptable. Note that when verification is not performed, the processing to be performed is fixed at the time the image processing conditions are set to the fine-scanned image processing section 58 by the parameter coordinating subsection 66, and then fine-scan is started.

The fine scan is performed similarly to the prescan except for the resolution and the reading conditions. The signal output from the CCD sensor 34 is processed by the amplifier 36 and the A/D converter 38, processed by the data processing section 46 of the processing apparatus 14, converted into fine-scanned data by the Log converter 48, and sent to the fine-scan memory 52.

When the fine-scanned data is sent to the fine-scan memory 52, it is read out by the fine-scanned image processing section 58 and processed in the image processing subsection 72 under the previously set image processing conditions including the sharpness gain as described above. The fine-scanned data having been processed in the image processing subsection 72 is then sent to the data converting subsection 74 and converted into image data adapted for image recording with the printer 16, and the image data is output to the printer 16 in which a print on which the image data is reproduced is created.

While the embodiment of the image processing apparatus of the present invention has been described above in detail, the present invention is by no means limited to the above embodiment and it goes without saying that various improvements and modifications can be made within the range which does not depart from the gist of the present invention.

While the example in which the present invention is applied to the digital photoprinter has been described above, the present invention can be also preferably utilized in the verifying operation of a conventional direct exposure type photoprinter.

As described above in detail, according to the present invention, since verification can be performed by displaying reference images having information of a scene and an image to be verified on the same display screen of a display, suitable verification can be performed more effectively and simply with pinpoint accuracy, which enables stable output of an appropriate photographic print on which an image of high quality is reproduced, with high productivity.

What is claimed is:

1. An image processing apparatus comprising:
a display;
an image processing unit for subjecting an image supplied from an image data supply source to image processing based on image processing conditions;
a memory for storing at least one first reference image;
a registration unit for registering said at least one first reference image in the memory;
a display unit for selecting at least one second reference image from said at least one first reference image and displaying on said display said at least one second reference image together with a finished-state-predicting image of the image processed by said image processing unit; and
a first adjustment unit for adjusting said image processing conditions in said image processing unit by using said at least one second reference image displayed on said display and said finished-state-predicting image.

2. The image processing apparatus according to claim 1, further comprising a moving unit for moving said second reference image displayed on said display.

3. The image processing apparatus according to claim 1, further comprising at least one of a reference image enlargement/reduction unit for enlarging or reducing said second reference image and a reference image partial display unit for partially displaying said second reference image.

4. The image processing apparatus according to claim 1, further comprising an output unit for outputting said first reference image stored in said memory as a hard copy; and a second adjustment unit for adjusting color and density of said first reference image stored in said memory.

5. The image processing apparatus according to claim 1, wherein said registration unit registers a plurality of first reference images for each group corresponding to an image scene and said display unit displays said plurality of first reference images for said each group.

6. The image processing apparatus according to claim 1, wherein said image processing unit also processes said finished-state-predicting image by using image processing conditions of said first reference image registered in the memory.

7. The image processing apparatus according to claim 1, wherein a color and a density residual of a calibration of an output device to which the image processed in said image processing unit is output are reflected on each of said first and second reference images.

8. The image processing apparatus according to claim 1, wherein an output device to which the image processed in said image processing unit is output and an output form used are selectable and said first adjustment unit modifies image processing conditions for said finished-state-predicting image in accordance with the output device and output form selected.

9. The image processing apparatus according to claim 1, wherein said registration unit registers image processing conditions for said finished-state-predicting image as image processing conditions for said first reference image.

10. The image processing apparatus according to claim 1, wherein said display unit displays said second reference image and said finished-state-predicting image in a partially overlapped state on said display and indicates by color or density a magnitude of at least one of a color difference and a difference in an image structure index between the second reference image and the finished-state-predicting image in the partially overlapped state.

11. The image processing apparatus according to claim 1, further including a unit for designating specific regions in said second reference image and said finished-state-predicting image displayed on said display, wherein said display unit indicates by color or density a magnitude of at least one of a color difference and a difference in an image structure index between said designated regions.

12. The image processing apparatus according to claim 10, wherein said image structure index is a power spectrum.

13. The image processing apparatus according to claim 1, wherein said memory stores said first reference image by colorimetric values.

14. The image processing apparatus according to claim 13, wherein said colorimetric values are XYZ values in a CIE1931 standard colorimetric system or L*a*b* values in a CIE1976L*a*b* perceived color space.

15. The image processing appratus according to claim 1, wherein said memory stores said first reference image by values on a standard color space.

16. The image processing appratus according to claim 15, wherein said standard color space is a sRGB trichromatic system.
